(19) United States
(12) Patent Application Publication
(10) Pub. No.: US 2008/0217996 A1
(43) Pub. Date: Sep. 11, 2008

(54) DATA TRANSMISSION DEVICE FOR AN AIRCRAFT

(75) Inventor: Frank Niss, Hamburg (DE)

Correspondence Address: MORRISON & FOERSTER LLP, 1650 TYSONS BOULEVARD, SUITE 400, MCLEAN, VA, 22102, US

(73) Assignee: Lufthansa Technik AG, Hamburg (DE)

(21) Appl. No.: 12/026,258

(22) Filed: Feb. 5, 2008

(30) Foreign Application Priority Data
Feb. 6, 2007 (EP) 07 002 563.0

(51) Int. Cl. B60L 1/00

(52) U.S. Cl. 307/9.1

(57) ABSTRACT

An aircraft has an on-board data network and an on-board electrical power supply system. The on-board electrical power supply system has a device for connection to a stationary electrical power supply system. An adapter device allows data transmission between the on-board data network and a stationary data network via the on-board electrical power supply system, the device for connection to a stationary electrical power supply system, and a stationary electrical power supply system. A ground device, equipped appropriately for data transmission, supplies the aircraft with electrical power.

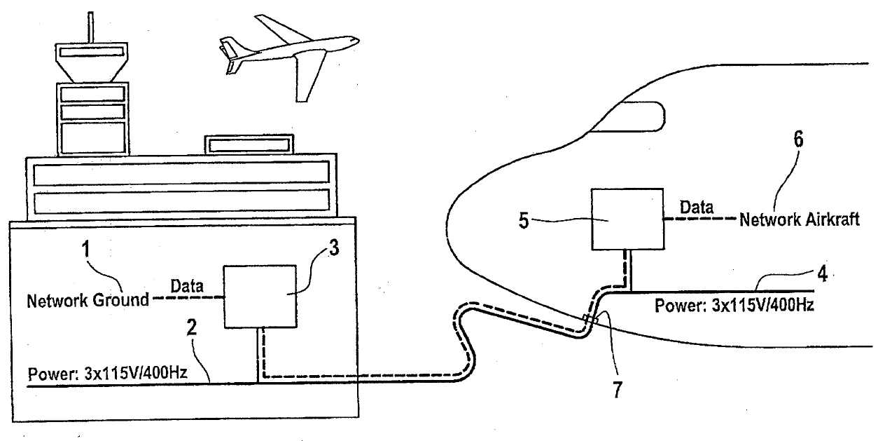

### CROSS REFERENCE TO RELATED APPLICATION

This application claims the priority of EPO Patent Application No. 07 002 63.0, filed Feb. 6, 2007, the contents of which are incorporated herein in their entirety.

### FIELD OF THE INVENTION

The invention relates to an aircraft having an on board data network and an on board electrical power supply system. The database on board the aircraft must be regularly updated. This relates not only to the aircraft operating systems but also to the entertainment program on-board long-haul aircraft. Relatively large amounts of data are involved, particularly when transmitting video files.

### BACKGROUND OF THE INVENTION

It is known from obvious prior use for data to be transmitted using the so-called gate link (a wire-free WLAN system) when the aircraft is parked at the gate. However, this wire-free transmission path is not used, or is used only with reluctance, for confidential system data, because of security reservations. The same reservations relate to the transmission of entertainment files such as films, which are subject to copyright protection.

### SUMMARY OF THE INVENTION

The invention is based on the object of providing a capability to transmit data to a network in an aircraft, which takes account of the security reservations and is in practical use without any problems.

The invention achieves this object by the features as broadly disclosed below.

### BRIEF DESCRIPTION OF THE DRAWING

The drawing illustrates an airport building and aircraft in accordance with an exemplary embodiment of the invention.

### DETAILED DESCRIPTION OF THE INVENTION

First of all, some of the expressions used for the purposes of the invention will be explained. An aircraft has an on-board electrical power supply system. This is normally a three-phase electrical power supply system (3×115V/400 Hz). In flight, electrical power is fed into this on-board electrical power supply system from generators which are arranged on one or more turbines. When the engines are shut down, the electrical power supply can be provided via a separate auxiliary power unit (APU), which is installed on-board.

For environmental and noise-protection reasons, operation of APUs is not allowed at many commercial airports, while the aircraft is parked at the gate. Instead of this, a coupling is provided on the outside of the aircraft, by means of which the electrical power supply system can be connected to a stationary electrical power supply system, and can be fed from this stationary electrical power supply system.

The expression on-board data network covers any device by means of which data communication can take place from/to on-board devices such as computers for controlling/monitoring equipment in the aircraft, computers or servers for cabin entertainment purposes, and the like. A data network such as this may, for example, be an Ethernet or some other wire-based or else wire-free network.

The expression stationary electrical power supply system refers to a ground electrical power supply system in particular at the airport, to which the on-board electrical power supply system can be connected. The expression stationary data network covers any devices which allow a connection to stationary computers or data storage facilities. The on-board and stationary data networks are preferably networks in accordance with conventional standards, which allow a plurality of computers or other data storage, processing or output devices to be connected to one another. However, for the purposes of the invention, the data networks may also be simple data lines which connect the adapter device to a computer or some other data storage, processing or output device.

The adapter device is a converter device which converts a data stream from the network to a form which can be transmitted via the line of the on-board and/or stationary electrical power supply system.

The invention allows secure data transmission, without any problems, from/to an aircraft which is parked at the gate. The connection of the ground electrical power supply system to the on-board electrical power supply system, which is provided in any case, allows the data connection to be made at the same time, with the network in the aircraft thus being connected to the network in the airport. The data transmission rate via the connected electrical power supply systems may correspond to that of a typical Ethernet and may be, for example, 10 MBit/s or 100 MBit/s. This is generally not sufficient to transmit a complete movie or a plurality of movies as video files during the time for which a long-haul aircraft is typically parked at the gate (1 hour). In practice, this is not a serious disadvantage since the films are generally available to the aviation companies about one month before their premier on-board and they can thus be transferred to the on-board computer in the aircraft successively during a number of ground stops.

Data is preferably transmitted via the electrical power supply system using radio-frequency signal transmission, with the radio-frequency being modulated onto the power supply system frequency (typically 400 Hz in the case of aircraft power supply systems). One preferred frequency band for modulated data transmission is between 4 and 30 MHz. The data transmission via the electrical power supply system can take place using a standard selected from the group comprising HomePlug 1.0, HomePlug AV (HomePlug Audio/Video, a standard for transmission at high data rates) and Digital Home Standards (a standard which has been developed by the Universal Powerline Association).

The subject matter of the invention is therefore on the one hand an aircraft which, according to the invention, is equipped to transmit data via the electrical power supply system and a ground electrical power supply system connection, and on the other hand a ground device in which a stationary network is equipped according to the invention for data transmission to an aircraft via the on-board electrical power supply system connection. The subject matter of the invention is also an arrangement including an aircraft according to the invention and the ground device at the airport, as well as the use of an arrangement such as this for transmission of data, in particular operating data for the aircraft or devices in it as well as video and/or audio data from and/or to an on-board memory device.

One exemplary embodiment of the invention will be explained in the following text with reference to the drawing. An airport building has a data network 1 which is connected to various data processing facilities that are not illustrated. Furthermore, the airport has a stationary electrical power supply system, which is represented by 2 and is intended to supply ground electrical power to aircraft parked at the gate. This is a three-phase electrical power supply system (3×115V/400 Hz). An adapter unit 3 modulates/demodulates data from the ground data network 1 onto the line of the stationary electrical power supply system 2.

The aircraft has an on-board data network 6, which is likewise connected to various on-board data processing facilities, including an audio/video server. An on-board electrical power supply system 4 is also provided. In this case, an adapter unit 5 is likewise used for modulation/demodulation of data onto and from the on-board electrical power supply system 4.

As soon as the aircraft parks at the gate, the stationary electrical power supply system 2 and the on-board electrical power supply system 4 are connected to one another via an aircraft ground electrical power supply system connection, which is indicated at 7. The electrical power is now supplied to the aircraft from the stationary electrical power supply system 2, and there is no need for the aircraft's own electrical power to be generated on-board the aircraft.

Data can now be interchanged via this connection between the two electrical power supply systems 2, 4 between the stationary, ground data network 1 and the on-board data network 6. The two adapter units 3, 5 for this purpose module/demodulate the data onto and from the connecting cables for the electrical power supply systems. This therefore allows secure and fast data transmission to and from the aircraft, without any need to connect separate data connecting cables for this purpose.

1. An aircraft comprising:
an on-board data network,
an on-board electrical power supply system having a device for connection to a stationary electrical power supply system, and
an adapter device that allows data transmission between the on-board data network and a stationary data network via the on-board electrical power supply system, the device for connection to the stationary electrical power supply system, and the stationary electrical power supply system.

2. The aircraft according to claim 1, wherein the data transmission is modulated with a frequency between 4 and 30 MHz.

3. The aircraft according to claim 1 or 2, wherein the data transmission is transmitted in accordance with a standard chosen from the group comprising HomePlug 1.0, HomePlug AV, and Digital Home Standards.

4. A system comprising:
a device for supplying an aircraft with electrical power from a stationary electrical power supply system, the stationary electrical power supply system having a device for connection to an on-board electrical power supply system in the aircraft, and
an adapter device that allows data transmission between a stationary data network and an on-board data network via the stationary electrical power supply system, the device for connection to the on-board electrical power supply system, and the on-board electrical power supply system.

5. The system according to claim 4, wherein the data transmission is modulated with a frequency between 4 and 30 MHz.

6. The system according to claim 4 or 5, wherein the data transmission is transmitted in accordance with a standard chosen from the group comprising HomePlug 1.0, HomePlug AV, and Digital Home Standards.

7. An arrangement including,
an aircraft according to claim 1, and
a system according to claim 4.

8. The arrangement according to claim 7, wherein the on-board electrical power supply system is connected to the stationary electrical power supply system.

9. A method comprising:
transmitting data to an on-board memory device using the arrangement of claim 8.

10. The method according to claim 9, wherein the data include operating data relating to one or more of the aircraft, video data and audio data.
